(19) United States
(12) Patent Application Publication
(10) Pub. No.: US 2003/0058980 A1
(43) Pub. Date: Mar. 27, 2003

(54) Method and apparatus for the transmutation of nuclear waste with tandem production of tritium

(76) Inventor: El-Badawy A. El-Sharaway, Gilbert, AZ (US)

Correspondence Address: Snell & Wilmer L.L.P., One Arizona Center, 400 East Van Buren, Phoenix, AZ, 85004-2202, US

(21) Appl. No.: 10/189,995

(22) Filed: Oct. 31, 2001

Related U.S. Application Data
(60) Provisional application No. 60/244,680, filed on Oct. 31, 2000.
(60) Provisional application No. 60/255,232, filed on Dec. 12, 2000.

(51) Int. Cl. G21G 1/10

(52) U.S. Cl. 376/195

(57) ABSTRACT

The transmutation of radioactive material using a hybrid transmutation reactor is disclosed wherein a kinetic proton source is used to collisionally induce the transmutation of radioactive material with the generation of thermal neutrons as a byproduct. Additionally, a system and method for the production of Tritium utilizing the thermal neutrons generated in the transmutation process is further described. The present invention offers advantages and improvements over existing nuclear reactor technologies in that nuclear waste may be rendered inert, or otherwise at least partially deactivated and/or made less dangerous, with the substantially simultaneous production of energy and/or Tritium as a byproduct of the transmutation process.

### RELATED APPLICATIONS

The present application claims the benefit of, and priority to, U.S. Provisional Application No. 60/244,680 filed Oct. 31, 2000 and U.S. Provisional Application No. 60/255,232 filed Dec. 12, 2000; the entire contents of which are hereby incorporated by reference.

### FIELD OF INVENTION

The present invention relates to nuclear reactions and quantum nucleonics. More particularly, the present invention relates to a method for: (1) the transmutation of radioactive material with a hybrid transmutation reactor; and (2) the production of Tritium (³H₁) in conjunction with the transmutation of radioactive waste.

### BACKGROUND OF THE INVENTION

Throughout the history of civilization, humans have consumed natural resources with the corresponding production of waste materials in order to produce energy. Since the industrial revolution, mankind has increasingly relied on the use of particular natural resources, such as fossil fuels, mineral resources, and more recently, atomic fission processes to produce energy. With respect to waste materials, approximately 400 commercial nuclear power plants are currently in operation around the world, which collectively discharge substantial volumes of radioactive spent fuel generally consisting of Uranium, Plutonium, actinides and other fission products. About 220,000 metric tons of spent nuclear fuel has been generated to date and the quantity is increasing at a rate of approximately 10,000 metric tons per year. See IAEA 1997b, p. 119; and Energy Information Administration, U.S. Department of Energy, World Spent Fuel Discharges, Reference Case, 1999-2020; both incorporated herein by reference. Uranium constitutes approximately 96% by weight of the spent fuel waste produced from commercial fission reactors, Plutonium constitutes 1% with minor actinides comprising about 0.1%; the remaining 2.9% of spent fuel is generally comprised of a variety of fission products such as Iodine, Technetium, Neodymium, Zirconium, Molybdenum, Cerium, Cesium, Ruthenium, Palladium, as well as others.

Many of these fission products maintain their radioactivity for considerable periods of time. The aggregate lifetime of a radioactive element is approximately equivalent to its half-life multiplied by 20 years. For example, the half-life of Strontium-90 is about 28 years, which generally corresponds to a total radioactive lifetime of about 560 years. Other radioactive isotopes, such as Plutonium-239, are even longer lived.

Given the long-lived character of many radioactive waste products, nuclear waste remediation has become a substantial governmental and public concern in the United States. There are currently at least 110 fission reactors in the U.S, which together generate approximately 3,000 tons of high-level nuclear waste annually.

Recent reports estimate that there is about 34,000 tons of domestic radioactive spent fuel that has already accumulated. However, the United States government has not developed a strategy for the comprehensive disposal of this material that poses such an on-going and substantial threat to public health.

The grave nature of the disposal problem is evident from many relatively recent reports. For example, an Apr. 8, 1992 article in The Arizona Republic newspaper (incorporated herein by reference) reported the results of a study conducted by the U.S. Environmental Protection Agency on radioactive sites in the United States. In that report, 45,361 locations were identified as having nuclear waste contamination ranging from moderate to severe. During the 1990's, the U.S. Department of Energy spent approximately $6 billion on a proposal to store 77,000 metric tons of radioactive waste in chambers bored out of the granite bedrock of Yucca Mountain, Nev. A Jul. 14, 1992 article in The San Jose Mercury News (incorporated herein by reference) reported that an earthquake the previous month had caused approximately $1 million in damage to a Department of Energy facility near the proposed Yucca Mountain site with the epicenter of the quake located just 12 miles away. See Science for Democratic Action vol.7, no. 3, May 1999, incorporated herein by reference. Moreover, a Jun. 14, 1991 article in The Arizona Republic newspaper (incorporated herein by reference) reported that mining experts for the $800 million Department of Energy facility designated for the initial U.S. tests of permanent radioactive waste disposal near Carlsbad, N. Mex. predicted that these deep underground salt chambers would likely collapse before the test could be completed.

The United States is not the only country burdened by the long-term problems associated with the disposal of nuclear waste. For example, a Sep. 2, 3, and 4, 1992 Los Angeles Times article (incorporated herein by reference) reported that from 1966 to 1992, Russia had been regularly dumping high-level nuclear waste into their rivers and lakes. From 1949 to 1956, nuclear waste from a Russian Plutonium refining facility was dumped into the Techa River, even though radioactivity began to appear one thousand miles downstream as early as 1953. Russia has also disposed of at least fifteen fission reactors, including six submarine Uranium fuel cores, in the Kara Sea which is generally thought to be at least partial responsible for mutagenic damage to many marine mammals in that habitat

Nuclear transmutation involves the transformation of a radioactive isotope into a new chemical element as a result of nuclear reactions or radioactive decay processes. Previously investigated processes of transmutations in high-level nuclear waste have involved the observation of β-decays of the relatively abundant fission products, Cesium and Strontium.

Transmutation processes involving the use of commercial fission reactors have generally implicated two reactions that have been of interest for their application to nuclear waste disposal and management; namely, (1) neutron capture; and (2) induced fission. Both the neutron capture and induced fission methods involve delivery of a suitable amount of energy, in the form of kinetic neutrons, to the nuclei of relatively long-lived radioactive isotopes in order to produce a reaction that would yield substantially shorter-lived radioactive isotopes or even stable elements.

The need for careful control of reaction progress is generally regarded as one of the disadvantages of kinetic neutron transmutation methods. Particularly, some neutron interactions with certain radioactive isotopes result in fission, while others result in the formation of even longer-lived isotopes. However, attempting to direct the overall conversion of long-lived radioactive isotopes to short-lived ones without a build up of even longer-lived species has proven difficult. On the other hand, fission transmutation reactions generally produce mostly short-lived fission products that decay into stable elements. For example, ¹⁰²Mo and ¹³⁵Te both undergo a series of beta decays; namely, the decay chain of ¹⁰²Mo is generally comprised of short-lived radioactive isotopes until it finally reaches the stable, non-radioactive isotope ¹⁰²Ru; however, ¹³⁵Te decays into a substantially longer-lived isotope (e.g, ¹³⁵Ce).

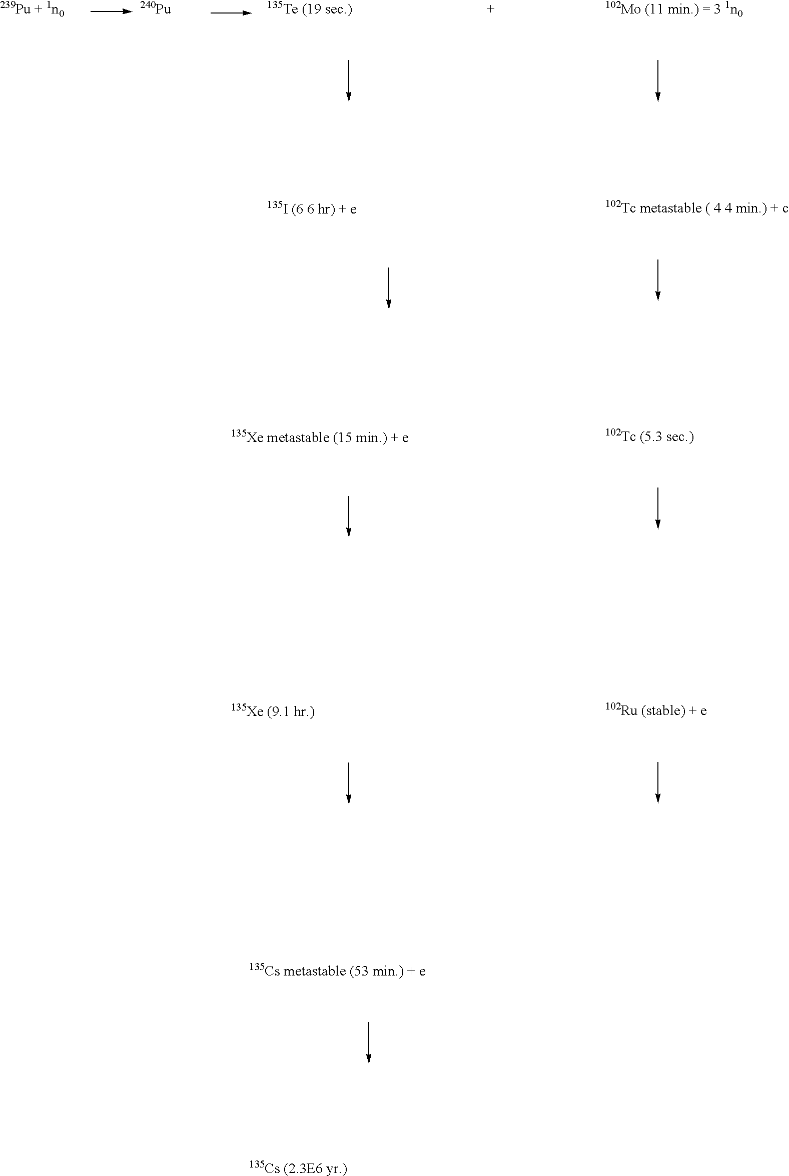

In an alternate method of transmutation, gamma irradiation of high-level nuclear waste has been investigated using ⁶⁰Co and ¹³⁷Cs sources. In these experiments, gamma rays radiolytically free neutrons from the nucleus resulting in the isotopic transmutation of the target. One of the general advantages of this type of irradiation is that gamma rays can easily penetrate sealed containers. However, prior art methods employing the use of gamma rays for the transmutation of nuclear waste have generally been limited to relatively weak dose rates on the order of 2.5E6 R/h, which corresponds to a relatively low transmutation cross-section.

In addition to the preceding methods for the transmutation of radioactive material, thermal proton applications have also been investigated. Kinetic proton methods have generally employed the use of linear accelerators (i e , LINAC's) for the production of proton beams having suitable kinetic energies to induce nuclear transmutation; however, many of the problems with proton LINAC methods have involved the difficulty of achieving these minimum activation energies. Additionally, realization of a proton LINAC device capable of continuous use has also proven difficult. See Kapchinsky I. M., et al., “Linear Accelerator for Plutonium Conversion and Transmutation of NPP Wastes”, in Proc. of the 1993 Particle Accelerator Conf., Washington, May 1993, pp. 1675-1680; Lawrence G. P., “Los Alamos High-Power Proton Linac Designs”, in Proc. of the Intern. Conf. on Accelerator-Driven Transmutation Technologies and Applications, Las Vegas, July 1994, pp 177-186; Fietier N., Mandrillon P., “A Three-Stage Cyclotron for Driving the Energy Amplifier”, CERN/AT/95-03 (ET); Reiser M., “Beam Physics Design Strategy for a High-Current RF Linac”, Ref.2, pp.364-370; Kolomiets A. A., “The Study of Nonlinear Effects Influenced by Space-Charge in High-Intensity Linac”, presented at 1995 Particle Accelerator Conference, Dallas; Andreev V. G., Paramonov V. V., “The Distortion of the Accelerating Field Distribution in Compensated Structures due to Steady-State Beam Loading”, presented at 1995 Particle Accelerator Conference, Dallas; Andreev V. A. and Parisi G., “90-apart-stem RFQ Structure for Wide Range of Frequencies”, Ref.1, pp. 3124-3126; Vorobjov I. A., Kolomiets A. A., “Matching of RFQ Beam with Periodic Focusing Structures”, in Proc. of the 1994 Intern. Linac Conf., Tsukuba, August 1994, pp. 558-560; all of which are incorporated herein by reference.

Tritium (³H₁) is a radioactive isotope of Hydrogen, which is typically used to enhance the explosive yield of thermonuclear weapons. As a radioisotope, Tritium decays at a rate of about 5.5% per year into a stable, non-radioactive isotope of Helium, namely Helium-3. Moreover, although Tritium is naturally occurring, the amount is generally too small for practical recovery; therefore Tritium generally is produced artificially, but has not been produced in the United States for several years.

A typical thermonuclear weapon usually consists of two stages, a primary stage where the explosion is initiated, and a secondary stage where the main thermonuclear explosion takes place. The yield of the primary stage, and its effectiveness in driving the secondary to explode, is enhanced by the action of Tritium gas which undergoes a nuclear fusion reaction with Deuterium, and generates a large amount of neutrons to ‘boost’ the nuclear burn of the Plutonium or highly enriched Uranium fuel core.

To compensate for decay losses, Tritium levels in the existing U.S. nuclear weapons arsenal are being maintained by recycling and reprocessing Tritium from dismantled nuclear warheads. It is generally believed that in order to maintain the nuclear weapons stockpile at the level called for in the Strategic Arms Reduction Treaty (START) II, a new Tritium source will be needed by the year 2011. See, Rowberg, Lau; Congressional Research Service Brief to Congress, 97002: The Department of Energy's Tritium Production Program; Sep. 10, 1998, incorporated herein by reference. Alternatively, if the U.S. wishes to maintain the START I stockpile levels, Tritium production could be needed by as early as 2005. Ibid.

Since Tritium is radioactive and has a relatively short half-life of a little over 12 years, the supply of Tritium in a newly manufactured weapon would decay by 5.5% per year to less than 1% of its original amount in seven half-lives (e g., 87 years) without replenishment. In the past, Tritium for replenishment of existing thermonuclear weapons was produced in a nuclear reactor, called the K-reactor, at the U.S. Department of Energy Savannah River Site in South Carolina. In 1988, the K-reactor was shut down due to safety concerns, and no substantial quantity of Tritium has been produced in the U.S. for weapons purposes since that time. However, replenishment of Tritium in the stockpile has continued by recycling Tritium from existing nuclear warheads as they are dismantled. In 1991, President George Bush signed the Strategic Arms Reduction Treaty II (START II), which committed the major nuclear powers to a large reduction in their nuclear weapons stockpiles. As a result of this reduction, the stockpile's Tritium levels have been maintained primarily by recycling the Tritium from deactivated warheads without new Tritium production. Currently, Canada and Russia are the world's largest producers of Tritium.

There are generally two methods of producing Tritium, both involving nuclear reactions using neutrons. In the first method, neutrons are made to strike a target consisting of a Lithium-Aluminum alloy. The neutrons react with the Lithium, producing Tritium and other byproducts. This technology was, used to produce Tritium for several decades at the Savannah River Site in South Carolina. In the second method, neutrons react with Helium-3 to produce Tritium and normal Hydrogen as by-products. Although this process has been demonstrated, the Helium-3 method has not generally been used in any known Tritium production system.

The U.S. Government is currently planning a 20 year research and development program for the storage and remediation of nuclear waste. This program is based, at least in part, on processes in which Uranium is initially removed from the waste samples, thereby reducing the mass of waste by 96%. Thereafter the Uranium may be enriched by well-known methods to produce fuel for nuclear fission reactors.

While there is general agreement on the processing of Uranium, there is ongoing uncertainty involving the remaining 4% of the nuclear waste. It has been proposed that further separation of the waste to extract Plutonium would significantly reduce the aggregate radioactivity of the remaining waste. Plutonium, and other long-lived waste, may then be exposed in a fast neutron reactor still under development with a target delivery sometime in 2015. This approach may involve several significant risks. The 4% of waste remaining from the Uranium separation is very toxic (e.g., about 2300 times more toxic than all of the 96% of separated Uranium) comprising the most radioactive component of the waste. This would seem to make chemical separation a significantly hazardous and expensive proposition. Also, the fast neutron reactor currently in development will be effective in reducing Plutonium, but will also generate secondary waste products as a result of Plutonium fission. The reaction rate of long-lived radioactive waste with neutrons is generally slow due to the large number of neutrons in their atoms; therefore, nuclear waste other than Plutonium may partially remain untransmuted. Additionally, the fast neutron reactor will have substantially the same safety and control issues that exist in current reactor design technology with only the accelerator driven component including a safer sub-critical control mechanism. Moreover, the accelerator component may require a significant amount of energy to operate a high-energy proton accelerator (i.e., 1 GeV protons); however, this technology is still under development and is expected to be quite expensive.

### SUMMARY OF THE INVENTION

The present invention generally provides for, inter alla, the transmutation of radioactive material using a hybrid transmutation reactor. A Helium-3/Deuterium component fusion fuel mixture is disclosed for use in a thermonuclear reactor such that thermal collision of Helium with Deuterium produces alpha particle fusion products in addition to Hydrogen nuclei (e.g., protons) having excess kinetic energy. The resulting thermal protons are employed to collisionally induce the transmutation of radioactive isotopes with the attendant generation of thermal neutrons and/or thermal electrons.

The present invention also includes a thermal neutron, water-cooled reactor with adapted waste cans that may be packed with waste that requires little or no chemical separation beyond that of Uranium removal. The reactor operates in a substantially continuous sub-critical mode providing for improved safety with respect to existing technology and reactor design currently under development. Heavy water may be used to thermally regulate the waste can core by operation of a heat exchanger to power turbine electric generators. Transmutation of the waste is achieved using relatively low energy protons which have a significant reaction rate with other protons to produce secondary neutrons which are used to drive the reactor in a sub-critical mode. The reactor will also ‘burn’ the Plutonium and minor actinides contained in the waste as well. Additionally, the present invention also allows for the substantially selective reaction between protons and long-lived components of the waste.

In a further aspect, the present invention also provides for the production of Tritium using thermal neutrons that are generated from the transmutation of radioactive material in the disclosed hybrid transmutation reactor device. Kinetic protons are used to induce the transmutation of radioactive isotopes with the attendant generation of thermal neutrons and/or thermal electrons. The thermal neutrons thereafter impact and react with, for example, a Lithium suspension to produce alpha particles and Tritium.

Yet a further benefit of the present invention is that it offers advantages and improvements over existing Tritium production technology in that a substantial quantity of Tritium may be obtained as a byproduct of nuclear waste remediation.

Additional advantages of the present invention will be set forth in the detailed description which follows, and in part will be obvious from the detailed description, the drawings, or may be learned by practice of the invention. The objects and advantages of the invention may be realized by means of the instrumentalities, methods and combinations particularly pointed out in the claims.

### BRIEF DESCRIPTION OF THE DRAWINGS

The features and advantages of the present invention reside in the details of construction and operation as more fully hereinafter depicted, described and claimed; reference being had to the accompanying drawings forming a part hereof, wherein like numerals refer to like parts throughout. Other features and advantages will become apparent to those skilled in the art in light of certain exemplary embodiments recited in the detailed description of the drawings, wherein:

FIG. 1 is a schematic side-view of an exemplary hybrid transmutation reactor in accordance with one embodiment of the present invention; and

FIG. 2 is a schematic side-view of an exemplary hybrid transmutation reactor in accordance with another embodiment of the present invention.

Other aspects and features of the present invention will be more fully apparent from the detailed description that follows.

### DETAILED DESCRIPTION OF EXEMPLARY EMBODIMENTS

The following descriptions are of exemplary embodiments of the invention and the inventor's conception of the best mode, and are not intended to limit the scope, applicability or configuration of the invention in any way. Rather, the following description is intended to provide convenient illustrations for implementing various embodiments of the invention. As will become apparent, various changes may be made in the function and arrangement of the elements described in these embodiments without departing from the spirit and scope of the invention. Various exemplary implementations of the present invention may be applied to any nuclear transmutation processes utilizing fusion reactions, fission reactions and/or any combination thereof. Certain representative implementations may include, for example: the remediation of low-level nuclear waste; the remediation of high-level nuclear waste; the generation of protons; the generation of neutrons; and the production of Tritium. As used herein, the terms “nuclear waste”, “radioactive waste” and “radioactive material”, or any variation thereof, are intended to describe anything that is currently susceptible to being characterized as comprising material having unstable or meta-stable nuclear states, or anything that may hereafter lend itself to the same or such similar characterization. The same shall properly be regarded as within the scope and ambit of the present invention. By way of example, a detailed description of an exemplary application, namely the remediation of high-level nuclear waste and the production of Tritium, is provided as a specific enabling disclosure that may be generalized by those skilled in the art to any application of the disclosed method and apparatus for nuclear transmutation, energy production and/or Tritium production in accordance with the present invention.

The subject invention, in one aspect, relates to the transmutation of nuclear waste. The exemplary embodiments set forth herein relate to a method and apparatus for transmuting nuclear waste while generating Tritium as a byproduct. It will be appreciated, however, by one skilled in the art that the principles of the present invention may be employed to ascertain and/or realize any number of other benefits associated with the disclosed hybrid method of transmuting nuclear waste, including, but not limited to, the improvement of: Tritium production, fusion cross-sections, fission cross-sections, and/or the density of externally radiated energy.

The present invention generally includes a method and apparatus for the transmutation of radioactive material utilizing kinetic protons generated, for example, by a thermonuclear fusion fuel mixture. In one exemplary embodiment of the present invention, a fusion reactor device may be fueled with a Helium-Deuterium gas mixture. Gaseous Helium-3 (³He₂) and Deuterium (²H₁) are introduced into the interior reaction chamber of, for example, a Tokamak reactor where they expand to substantially fill the volume of the reaction chamber. External high-frequency (˜70 kHz or greater) radio wave sources are then engaged to deposit electromagnetic energy in the reaction chamber to heat the gaseous fuel components. As the fuel is heated with the harmonic application of electromagnetic radiation, valence electrons of the fuel atoms are thermally ionized leaving positively charged nuclei and free electrons (e.g., plasma) in the reaction chamber. Strong magnetic fields are then engaged to confine the charged particle plasma in, for example, an axially symmetric magnetic containment envelope generally having a ‘donut-like’ shape.

As the plasma is drawn into a contained envelope, the density of the plasma increases with the corresponding reduction in free volume; this has the general advantage of substantially increasing the collisional cross-section between and among ionized nuclei, thereby substantially increasing the probability of a collision having sufficient energy capable of resulting in the fusion of the participating nuclei (e.g., the “fusion cross-section”).

Generally for a monatomic gas, the kinetic energy of any non-relativistic atom is given as

$$\frac{3}{2} kT ;$$

where k is the Boltzmann constant and T is the temperature. Given the Coulombic repulsion potential of the nuclei as V(x), where x is a measure of the inter-nuclear distance of two approaching nuclei, the minimum condition for fusion of the participating nuclei is given by:

$$\frac{3}{4} kT \geq V ( {x}^{†} )$$

. . . where x^{↑}is the inter-nuclear distance corresponding to the maximum coulombic repulsion experienced by the approaching nuclei. The monatomic energy factor of

$$\frac{3}{4} kT$$

is generally considered the minimum conditional constraint because two nuclei on a direct collision course, where neither particle has a vector projection of momentum perpendicular to the collisional axis, would each possess a kinetic energy of

$$\frac{3}{4} kT$$

resulting in a total relative kinetic energy for that sub-system of

$$\frac{3}{4} kT .$$

As the radio frequency source harmonically pumps increasing quantities of electromagnetic energy into the plasma, the temperature T of the plasma is raised in proportion to the increase in kinetic energy of the nuclei confined therein. When the temperature T satisfies the minimum fusion condition

$$\frac{3}{4} kT \geq V ( {x}^{†} ) ,$$

thermal fusion of Helium-3 with Deuterium, for example, produces an alpha particle product in addition to an emitted proton having substantial excess kinetic energy given by:

³He₂+²H₁→⁴He₂+¹H₁+16 MeV

Any fuel system capable of directly or indirectly generating kinetic protons now known or hereafter derived by those skilled in the art, may be used to fuel the fusion reaction. In an exemplary embodiment of the present invention, at least one additional fuel component may also be used in concurrent or consecutive use to substantially contribute to the uniform thermalization of the plasma such as, for example, heavy-Lithium (⁷Li₃). Another embodiment of the present invention may include at least one additional binary fuel system in concurrent or consecutive use to substantially contribute to the retention of a greater quantity of energy in the plasma to sustain the reaction such as, for example, heavy-Lithium (⁷Li₃) and Hydrogen (¹H₁). Yet another embodiment of the present invention may include at least one additional binary fuel system in concurrent or consecutive use to substantially contribute to the release of a greater quantity of energy from the plasma such as, for example, Deuterium (²H₁) and Tritium (³H₁).

Another exemplary embodiment of the present invention may include the step of adding Hydrogen (¹H₁) to the thermonuclear plasma fuel mixture in order to generally improve, for example: (1) the uniform thermalization of the plasma; (2) the fusion cross-section; and (3) the production of kinetic protons. Additional, alternative methods of plasma confinement including, for example, inertial confinement, electrostatic confinement and/or any other methods of confinement now known or hereafter derived by those skilled in the art of atomic fusion, may also be used to confine the hot plasma.

The present invention inter alia offers substantial advantages and improvements over existing thermonuclear technology in that a considerable population of high-energy protons may be obtained from the confined fusion reaction of Helium-3 with Deuterium, which may be subsequently employed in the transmutation of nuclear waste and other radioactive material.

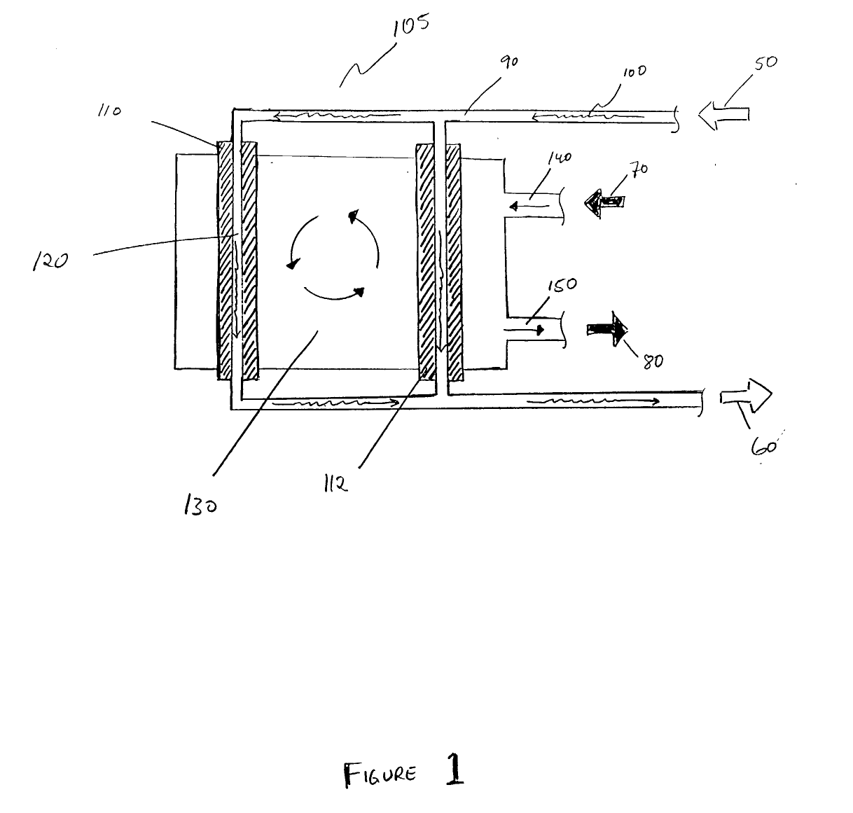

In accordance with an exemplary embodiment of the present invention as depicted for example in FIG. 1, a hybrid transmutation reactor 105 is configured to at least partially deactivate radioactive material. The hybrid transmutation reactor 105 comprises, for example: at least one waste can (for example, either of 110, 112) for fueling the reactor with radioactive waste; a proton beam track 90 for channeling kinetic protons 100 to the reaction zone 120 disposed within the interior of said waste cans 110; means 50 for producing kinetic protons 100, such as, for example, the fusion method previously disclosed; means 60 for removing and/or recycling protons 100 that may exit the reaction zone; and a reactor coolant sub-system 130 including means 70 for feeding cooled coolant (e.g., using heat dissipating means 80) to dissipate heat generated at or near the reaction zone 120. Means 50 for producing kinetic protons 100 and means 60 for removing and/or recycling protons 100 may include any of: a Tokomak reactor; an ICF reactor; an IEC reactor; a LINAC; a cyclotron or any device or method for generating and/or accelerating protons now known or hereafter derived by those skilled in the art. Reactor coolant sub-system 130 may additionally include various pumping and/or control equipment, a heat exchanger and/or a turbine generator.

As coolant flows into (140) the reactor bath 130 in one embodiment of the present invention, the coolant absorbs heat generated in the transmutation process from the reaction zone 120. The heated coolant then flows out (150) of the reactor bath 130 where the thermal gradient between the heated coolant 150 and the cooled coolant 140 is used, for example, to generate electric power.

In one exemplary embodiment of the present invention, a kinetic proton may be directed to collisionally induce the transmutation of a radioactive isotope in accordance with either of the following reactions:

^{z}Aₘ+¹H₁→^{z}Aₘ₊₁+¹n₀

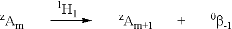

. . . wherein,

^{z}Aₘ=the radioactive isotope to be transmuted;

¹H₁=the thermal proton generated from the fusion of, for example, Helium-3 with Deuterium;

¹n₀=a thermal neutron;

⁰β₋₁=a thermal electron (e.g., beta particle); and

^{z}Aₘ₊₁=the non-radioactive (or otherwise at least partially deactivated) transmutation product.

As thermal protons 100 bombard the radioactive waste material in the waste cans 110, 112, neutron and/or electron transmutation byproducts are produced in and escape from the reaction zone 120. In another alternative exemplary embodiment of the present invention, the radioactive waste may be chromatographically isolated or otherwise pretreated to obtain a substantially optimized isotopic distribution prior to subsequent transmutation.

In one exemplary embodiment of the present invention, the transmutation reactor core 120 is generally disposed within the interior portion of a cooling bath 130 containing, for example, at least a suitably adapted suspension of Lithium-6 (⁶Li₃). As thermal neutrons propagate away for the fusion reactor core, they collide with the Lithium in the coolant to kinetically induce the following reaction:

⁶Li₃+¹n₀→₄He₂+³H₁

In another exemplary embodiment of the present invention, the coolant vessel may conjunctively, consecutively or alternatively contain at least a suitable suspension of Helium-3 for collisional reaction with thermal neutrons to produce Tritium in accordance with the following reaction:

³He₂+¹n₀→¹H₁+³H₁

The resulting Tritium (³H₁) that is produced may then be drawn out of the Lithium-6 and/or Helium-3 suspension for storage and use in other applications well known in the art. One additional exemplary application of Tritium may include that of at least partially fueling the further production of kinetic protons.

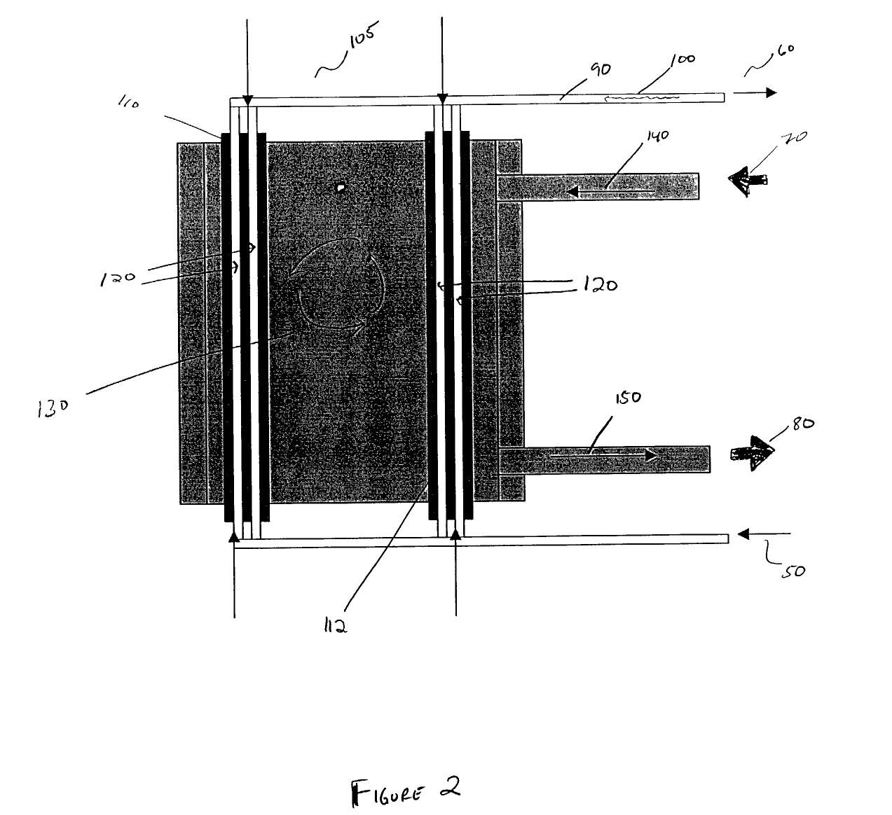

In yet a further alternative exemplary embodiment, as depicted for example in FIG. 2, multiple reaction zones 120 may be configured within the waste cans 110, 112. Those skilled in the art will appreciate that a variety of reaction zone geometries and/or configurations may be used in one or more waste can assemblies to facilitate, control or otherwise optimize the sub-critical transmutation reaction.

Radioactive isotopes having a large number of excess neutrons generally exhibit a good reaction cross-section with protons (i.e., ¹⁸O vs. ¹⁶O, ¹⁴C vs. ¹²C, etc.). This reaction rate with protons may generally be increased by four or more orders of magnitude due to the presence of excess neutrons, assuming that the energy of the protons is relatively small. This phenomenon provides inter alia a mechanism for targeting a selective reaction where protons react principally with the radioactive isotopes with a relatively low statistical probability of reaction with other elements, generally minimizing the proton dose that may be required to initiate the ‘burn’ of the nuclear waste fuel in the hybrid reactor of the present invention.

There are several advantages that the present invention offers over the fast neutron byprocess approach currently under research and development by the U.S. Government and others: (1) little or no chemical separation is required beyond the removal of Uranium; (2) transmutation of primary and secondary waste includes long-lived components due to substantially steady stream of protons used for transmutation of both generation of transmutation products; (3) relatively low energy is needed to drive the proton source; (4) sub-critical control is much safer and can be shut down or otherwise attenuated almost instantly by disengagement of the proton beam source; and (5) the proton source can be obtained through fusion of ³He and ²H or by low energy accelerators which can provide a large dose of protons to allow for fast transmutation.

The reactor, depicted for example in FIG. 1, may be a water-cooled reactor in one embodiment of the present invention of about 1 to 1.5 meters in height. In a exemplary application, the nuclear waste may be stored in waste cans 110, 112 with diameters of about 10 to 30 inches. In an exemplary embodiment, in accordance with the present invention, pellets coated with a passive layer, such as C or SiC may be used, wherein the radius of the pellet is typically on the order of about 1 to 2 mm in diameter. The pellets may be placed, for example, in the interstitial spaces between passive hollow containment tubes made of C, SiC or any other material that will substantially retain its material characteristics upon exposure to ionizing radiation. The diameter of the tubes, in one embodiment, is about 1 to 2 inches with minimal wall thickness to reduce any energy loss in the tubes. The coupling efficiency of proton delivery to the waste cans may be increased by, for example, making holes on the surface of the containment tube. The diameter of the containment tubes must generally be less than the diameter of the waste pellets (i.e., 1 to 2 mm).

In an alternative exemplary embodiment of the present invention, tubes of about one inch in diameter may be fabricated from the nuclear waste material itself. The wall thickness of the tubes corresponding to this embodiment may be less than about 2 mm in thickness with an effective number of relatively small holes in the containment tube walls in order to generally improve the proton coupling efficiency.

In an exemplary operational mode, the waste cans 110, 112 may be configured at an angle of up to about 5 degrees relative to the proton trajectory in order to distribute the proton dose more uniformly to the waste. In an exemplary embodiment, ⁴He may be employed to flow through the containment tubes in order to cool the waste cans. In one operational embodiment where the Helium coolant exiting the reactor is about 600° F., the Helium coolant may be optionally used to super heat or reheat water vapor from the primary coolant sub-system 130 to increase the efficiency of the reactor.

To determine the waste pellet diameter and/or the containment wall thickness, the approximate range of 14.7 MeV protons which result from the ³He and ²H fusion reaction may be estimated in various materials. Using the standard Bethe equation for energy loss of electrons, results for the following solid materials are:

| MATERIAL | -dE/dx (MeV/cm) | Approx. Range (mm) |
|---|---|---|
| Strontium 90 | 46 | 3.2 |
| Cesium 137 | 29 | 5.0 |
| Zirconium 93 | 118 | 1.2 |
| Technetium 99 | 207 | 0.7 |
| Plutonium 239 | 267 | 0.6 |

The range of protons in solid materials of interest suitably adaptable to the present invention is on the order of a few millimeters. This would suggest that any waste that is bombarded by low energy protons may be only a few millimeters thick if the protons are to reach a substantial number of atoms in the waste.

In accordance with various aspects of the present invention, a number of transmutation paths may be accomplished, such as, for example:

(1) ¹⁰⁶Ru produces ¹⁰⁷Rh which beta decays to ¹⁰⁷Pd with a half-life of 21.7 minutes, ¹⁰⁷Pd beta decays to ¹⁰⁷Ag with a half-life of 6.5 million years, ¹⁰⁷Ag is stable;

(2) ¹⁰⁷Pd produces ¹⁰⁸Ag which beta decays to ¹⁰⁸Cd which is stable and electron captures to ¹⁰⁸Pd which is also stable, these processes have a half-life of 2.37 minutes, there is a meta-state of ¹⁰⁸Ag which electron captures to ¹⁰⁸Pd with a half-life of 418 years;

(3) ¹²⁹I produces ¹³⁰Xe which is stable;

(4) ¹³⁵Cs produces ¹³⁶Ba which is stable;

(5) ¹³⁴Cs produces ¹³⁵Ba which is also stable;

(6) ¹⁴⁷Pm produces ¹⁴⁸Sm which alpha decays to ¹⁴⁴Nd with a half-life of 7E15 years; and

(7) ¹⁵⁴Eu produces ¹⁵⁵Gd which is stable.

The above reactions will also emit several neutrons as well which may make the isotopes even more stable. These neutrons split the ²³⁹PI and drive the reactor in a sub-critical mode. The safety of such a sub-critical reactor may be significantly enhanced with the optional utilization of, for example, electronic control of the proton source power supply. Those skilled in the art will generally recognize that this would be significantly safer and more reliable than mechanical control mechanisms, such as; for example, the insertion of Boron control/moderator rods typically used in existing fission power plant reactors.

If the proton beam is adapted to carry about 1 ampere per square centimeter, the corresponding beam density will be on the order of 1E9 particles per cubic centimeter. The nuclear waste target density is taken to be about 5E22 particles per cubic centimeter and the beam velocity is about 5E9 centimeters per second. If the reaction cross-section is one barn (e.g., 1E-24 cm²), then the reaction rate would be about 2.5E17 per cubic centimeter per second. In a waste sample 2.5 mm thick and one square centimeter in area, there would be about 6E16 reactions per second One ampere of protons bombarding this area corresponds to approximately 6.25E18 protons incident per second. Assuming a steady dose and minimal loss of protons, on the order of 10 amps is generally considered to be sufficient to drive a sub-critical transmutation reactor for three years to deplete the nuclear waste fuel. As the reaction progresses, the production of neutrons decreases over time. Since neutrons split the ²³⁹PI isotopes to drive the transmutation reaction, one-half to one-third of the waste cans may be changed-out with fresh fuel each year of operational duty cycle to normalize the neutron dose. Additionally, in another exemplary embodiment, a ⁶Li blanket may be configured in solid or suspended form to absorb protons when the reaction rate is strong in order to flatten the ²³⁹PI rate of reaction. The reaction of ⁶Li with a neutron to produce ⁴He and Tritium may also be used for biomedical and/or other applications previously discussed.

In the foregoing specification, the invention has been described with reference to specific embodiments. However, it will be appreciated that various modifications and changes can be made without departing from the scope of the present invention as set forth in the claims below. The specification and figures are to be regarded in an illustrative manner, rather than a restrictive one, and all such modifications are intended to be included within the scope of the present invention. Accordingly, the scope of the invention should be determined by the appended claims and their legal equivalents, rather than by merely the examples given above. For example, the steps recited in any of the method or process claims may be executed in any order and are not limited to the order presented in the claims.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing or design parameters or other operating requirements without departing from the general principles of the same.

What is claimed is:

1. A hybrid transmutation method for facilitating at least partially deactivating radioactive material, comprising the steps of.
providing a source of kinetic protons;
providing a reaction zone;
placing a radioactive material target within said reaction zone; and
introducing said kinetic protons to impact said radioactive target to induce at least partial isotopic transmutation of said target radioactive material.

2. The method according to claim 1, wherein said kinetic proton source is at least one of a Tokomak fusion reactor, an ICF fusion reactor, an IEC fusion reactor and a LINAC.

3. The method according to claim 1, wherein said reaction zone is disposed within a waste can for substantially confining said radioactive material.

4. The method according to claim 1, wherein said radioactive material is at least one of radioactive isotopes, high-level nuclear waste, low-level nuclear waste and at least one isotopic component of nuclear waste.

5. The method according to claim 1, wherein successive isotopic transmutation results in a substantially non-radioactive multi-generational transmutation product.

6. The method according to claim 1, further comprising the step of cooling the transmutation reaction zone to produce a thermal gradient.

7. The method according to claim 6, further comprising the step of using said thermal gradient to produce power.

8. The method according to claim 7, wherein the thermal gradient is used to produce mechanical power.

9. The method according to claim 7, wherein said thermal gradient is used to drive a turbine generator to produce electric power.

10. The method according to claim 1, wherein said source of kinetic protons provides a proton beam having an energy of about 10 amps.

11. A hybrid transmutation apparatus for facilitating at least partially deactivating radioactive material, comprising:
a source of kinetic protons;
a reaction zone; and
a radioactive material target within said reaction zone.

12. The hybrid transmutation apparatus according to claim 11, wherein said kinetic proton source is at least one of a Tokomak fusion reactor, an ICF fusion reactor, an IEC fusion reactor and a LINAC.

13. The hybrid transmutation apparatus according to claim 11, wherein said reaction zone is disposed within a waste can for substantially confining said radioactive material.

14. The hybrid transmutation apparatus according to claim 11, wherein said radioactive material is at least one of radioactive isotopes, high-level nuclear waste, low-level nuclear waste and at least one isotopic component of nuclear waste.

15. The hybrid transmutation apparatus according to claim 11, wherein successive isotopic transmutation results in a substantially non-radioactive multi-generational transmutation product.

16. The hybrid transmutation apparatus according to claim 11, further comprising means for cooling the transmutation reaction zone to produce a thermal gradient.

17. The hybrid transmutation apparatus according to claim 16, further comprising means for using said thermal gradient to produce power.

18. The hybrid transmutation apparatus according to claim 17, wherein the thermal gradient is used to produce mechanical power.

19. The hybrid transmutation apparatus according to claim 17, wherein said thermal gradient is used to drive a turbine generator to produce electric power.

20. The hybrid transmutation apparatus according to claim 11, wherein said source of kinetic protons provides a proton beam having an energy of about 10 amps.

21. A hybrid transmutation reactor method for facilitating the production of thermal neutrons, comprising the steps of:
providing a source of kinetic protons;
providing a reaction zone;
providing a radioactive material target within said reaction zone; and
introducing said kinetic protons to impact said radioactive material to induce at least partial isotopic transmutation of said target radioactive material with the production of thermal neutrons as a product of the transmutation reaction.

22. The method according to claim 21, wherein said kinetic proton source is at least one of a Tokomak fusion reactor, an ICF fusion reactor, an IEC fusion reactor and a LINAC.

23. The method according to claim 21, wherein said reaction zone is disposed within a waste can for substantially confining said radioactive material.

24. The method according to claim 21, wherein said thermal neutrons are used to produce electric power.

25. The method according to claim 21, wherein said thermal neutrons are used to produce Tritium.

26. A hybrid transmutation reactor method for facilitating the production of Tritium, comprising the steps of:
providing a source of kinetic protons;
providing a reaction zone;
providing a Tritium nucleonic precursor suspension exterior to said reaction zone; and
using said kinetic protons to generate, substantially in situ, thermal neutrons,
impacting said thermal neutrons with said Tritium precursor to produce Tritium.

27. The method according to claim 26, wherein said source of kinetic protons is at least one of a Tokomak fusion reactor, an ICF fusion reactor, an IEC fusion reactor and a LINAC.

28. The method according to claim 26, wherein said Tritium nucleonic precursor is at least one of Lithium-6 and Helium-3.

29. A hybrid transmutation reactor apparatus for facilitating the production of electric power in tandem with the transmutation of nuclear waste, comprising:
a source of kinetic protons;
a reaction zone;
a radioactive waste target within said reaction zone;
means for introducing said kinetic protons to impact said radioactive waste target;
a coolant bath in substantial thermally conductive contact with said reaction zone, and
means for converting the heat deposited in the coolant bath to electric power.

30. The apparatus according to claim 29, wherein said means for converting the heat deposited in the coolant bath comprises a steam-driven turbine generator.

31. A hybrid transmutation reactor apparatus for facilitating the production of Tritium, comprising:
a source of kinetic protons;
a reaction zone,
a radioactive waste target within said reaction zone,
means for introducing said kinetic protons to impact said radioactive waste target;
a coolant bath in substantial thermally conductive contact with said reaction zone;
said coolant bath further comprising a suspension of Lithium-6; and
means for removing Tritium from the coolant suspension.

32. A hybrid transmutation apparatus for facilitating the remediation of nuclear waste, comprising:
a source of kinetic protons;
a reaction zone;
a nuclear waste target within said reaction zone;
means for introducing said kinetic protons to impact said radioactive waste target;
a coolant bath in substantial thermally conductive contact with said reaction zone,
said coolant bath further comprising a suspension of Lithium-6,
means for removing Tritium from the coolant suspension; and
a heat exchanger and turbine generator for converting the heat deposited in the coolant bath to electric power.
